(19) United States
(12) Patent Application Publication
(10) Pub. No.: US 2008/0065508 A1
(43) Pub. Date: Mar. 13, 2008

(54) Web-based marketplace for product placement and brand integration

(75) Inventors: Hamet A. Watt, Los Angeles, CA (US); Terrance T. Coles, Murrieta, CA (US); Jason K. Kwong, Sherman Oaks, CA (US); Sridhar Obilisetty, Cupertino, CA (US)

Correspondence Address: LAW OFFICE OF DAVID H. JUDSON, 15950 DALLAS PARKWAY, SUITE 225, DALLAS, TX, 75248, US

(73) Assignee: NextMedium, Inc., Los Angeles, CA (US)

(21) Appl. No.: 11/748,670

(22) Filed: May 15, 2007

Related U.S. Application Data
(60) Provisional application No. 60/800,346, filed on May 15, 2006.

(51) Int. Cl. G06Q 30/00

(52) U.S. Cl. 705/26

(57) ABSTRACT

The present invention describes an online, electronic marketplace for brand integration and product placement. The system provides entertainment companies the opportunity to present their available brand integration inventory, while providing advertisers and their agencies a single source to monitor brand integration options, as well as a forum in which to transact directly with entertainment providers. The system preferably leverages both historical and forward looking data. The platform enables a buyer or seller to view or offer brand integration opportunities across multiple mediums (e.g., television, film, music, video games, and the like), to search opportunities by product category, demographic, or entertainment medium, to sort opportunities by price or date, and to validate post-deal brand integration effectiveness using a defined set of product placement-specific metrics. The system provides brand integration opportunities to be bought and sold throughout an entire lifecycle (pre-production, production, post-production, broadcast/distribution and post-broadcast) of a given program.

This application is based on and claims priority to Ser. No. 60/800,346, filed May 15, 2006.

This application includes subject matter that is protected by copyright.

### BACKGROUND OF THE INVENTION

1. Technical Field

The present invention relates generally to methods and systems for managing product placement and brand integration campaigns over a computer network, such as the Internet.

2. Description of the Related Art

As the proliferation of DVR-enabled ad-skipping technologies contributes to the decline of the traditional 30-second commercial, non-traditional advertising alternatives, such as brand integration, are becoming a more significant part of today's media mix. Unfortunately, entertainment companies and advertisers struggle with the inefficient process of defining, measuring and managing brand integration transactions. A primary issue today is the problem of matching buyers to product placement opportunities, which typically remains a manual process. The specific arrangements are usually handled by product placement entities, who work with a producer or a network to map a brand to an opportunity, or via some personal relationship or other arrangement between the buyer and the seller. Moreover, there is a lack of effective means by which the parties to a product placement transaction can measure its value. Today, a traditional television advertising metric (GRP, or Gross Rating Points) is applied to measure advertisement efficacy, but the metric is just a count of a total number of captive viewers watching a given show per unit time. Product placement value is more difficult to gauge, as the effectiveness of a given placement often depends more on context; thus, e.g., the product placement is more valuable if the brand is mentioned by a lead actor as opposed to being seen as a background prop. As a result of weak measurement data for product placements, it has been very difficult to attach a meaningful value to such opportunities. Without such objective data, negotiations for branding opportunities are ad hoc and, as a result, the price paid for a given opportunity may have no relation to its true value.

There remains a need to provide technology solutions that can help brands, ad agencies, media buyers, and brand integration agencies make the most informed brand integration decisions.

### BRIEF SUMMARY OF THE INVENTION

It is a general object of the present invention to provide a technology platform that allows for better utilization of brand integration (media-embedded advertising). In one embodiment, a web-based hosted solution (a managed service or system) provides an online, electronic marketplace for brand integration and product placement. The system provides entertainment companies the opportunity to present their available brand integration inventory, while providing advertisers and their agencies a single source to monitor brand integration options, as well as a forum in which to transact directly with entertainment providers. The system preferably leverages both historical and forward looking data. Using the technology platform, a buyer or seller can view or offer brand integration opportunities across multiple mediums (e.g., television, film, music, video games, and the like), search opportunities by product category, demographic, or entertainment medium, sort opportunities by price or date, and validate post-deal brand integration effectiveness. The system preferably exports a web interface to enable end user entities (buyers and sellers) to transact with the system over the Internet using conventional technologies (a computer having a web browser and network connectivity) and using standard communication techniques (HTTP, secure HTTP, SOAP-based web service, or the like). Alternatively, the system is implemented as an extranet, over a private network, or the like. Preferably, entities access the hosted solution on a subscription basis, although a given entity may also elect to access the service on a transaction-based basis.

The inventive system manages “avails.” An “avail” is a shorthand reference to an aspect of a production that is “available” for potential product placement and brand awareness. Typically, an “avail” is an opportunity for an advertiser to include its brand as part of a given production. A “buyer” may also be an advertising agency, a media buyer (working on behalf of an advertiser), or another entity such as the service provider of the hosted platform. An “avail” may also refer to an opportunity that is entered into the system by the seller, or on behalf of the seller. Typically, a “seller” is a producer (e.g., the sales team at a production company), an entertainment network (e.g., the sales team at a given network), a film production house, a music video company, a video game producer, or the like. As noted above, any such buyer or seller entity interacts with the platform over the Internet or other private network, preferably using a web browser or other graphics display engine. The system allows sellers to create, store, respond to, and transact on new avails. Similarly, the buyer uses the system to follow the progress of its offers, to respond to, and to close on avail buying opportunities.

According to another feature of the invention, the system defines a set of one or more product placement-specific metrics that are used on the platform as a standard measure of delivery of exposure across avails. A first metric is a brand integration unit (UBI™) that, in a representative embodiment, is a function of: exposure duration (typically measured in seconds) times a given audience size metric (e.g., household (HH) gross rating points (GRP), such as available from Neilsen or other sources) times a given product placement type factor or attribute. A “placement type” is a type of product placement within a given production, e.g., a foreground placement, a background placement, a brand mention, a dialogue mention, a dialogue mention by a given character, use as a prop, use in wardrobe, use in a storyline, use as the storyline, or the like. Preferably, different weights are associated with each placement type, thus influencing the brand integration unit value calculation. The weight values may be informed or influenced by historical data or other statistics. A second metric is an aggregate of brand integration units, e.g., over all media, or with respect to a specific media type, over a continuing time period. This second metric is sometimes referred to herein as an ENTERTAINMENT INTEGRATION QUOTIENT™ (or E*IQ™). Typically, an end user entity buys a UBI and the system measures E*IQ, which value typically increases over time and use of the system. E*IQ thus is an aggregated view of the effectiveness of a brand across some or all of the media types over time. A third metric is a media value, which represents, once again for a given time period, a monetary amount typically calculated as E*IQ times a quotient of: average advertising rate and average audience size (e.g., measured as HH GRP or equivalent). The media value may be calculated and displayed on an aggregate media basis, or with respect to a specific media type, or the like.

A hosted solution according to the invention provides the marketplace participants with the ability to track and manage product placement and brand integration opportunities throughout an entire media production and distribution lifecycle that includes: pre-production, production, post-production, broadcast/distribution, as well as post-broadcast interactivity or other transactional commerce. Thus, for example, in pre-production, a seller can reveal an apparel opportunity for a popular television show (e.g., “in scene 1, the lead character walks into a room with a red shirt”). In the production phase, a buyer (e.g., Nike, Gap, Abercrombie & Fitch, or the like) can then bid on the avail and, if the bid is accepted, purchase the opportunity. Or, assuming the opportunity is not then closed, an entity may decide to make a bid during the post-production phase because it has determined that the production, the expected audience, and the placement duration represent a possible high E*IQ. During the broadcast distribution phase, a buyer may even purchase an avail if its brand or branded product can be placed into the production in a “virtual” manner (e.g., as a display overlay). Even following broadcast distribution, yet another buyer can purchase an opportunity with respect to downstream distribution (such as foreign broadcast rights). Thus, in a first broadcast run, the character might be wearing a red shirt branded with the Nike® logo, while the foreign broadcast of the same production will have the character wearing a red shirt branded with the Lacoste® logo. As can be seen then, using the platform, different buyers can offer different product placements throughout the production and distribution lifecycle of a given creative.

The platform also enables a buyer to make an offer for an avail at a fixed price, or on a pay-for-performance basis. In the latter case, the buyer can specify a number of criteria, such as: a maximum offer amount, an integration placement type (such as prop, brand mention, background, foreground, and the like), as well as a cost per second with respect to a given placement type.

The platform provides a full end-to-end system that combines core marketplace functionality with detailed analytics and flexible workflow tools to enable brands to effectively increase their exposure inside entertainment content and entertainment companies to effectively monetize air- or display-time for brand exposures inside their entertainment content. The system may obtain and display historical data from third party measurement sources, and integrate that data with qualitative data to differentiate placement and integration effectiveness.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 is a block diagram of a service provider infrastructure for implementing a brand integration technology platform according to the present invention;

FIG. 2 is a representative home or “portal” page from which an end user can navigate throughout the system functions;

FIG. 3 is a representation page that is displayed by the system when the end user selects the Introduction link in the Gauge your exposure subdirectory identified in the navigation panel;

FIG. 4 is a representative page that is displayed by the system when the end user selects the E*IQ details summary link in the navigation panel;

FIG. 5 is a representative page that is displayed by the system when the end user selects the Top competitors by E*IQ link in the navigation panel;

FIG. 6 is a representative page that is displayed by the system when the end user selects the Top placements by E*IQ link in the navigation panel;

FIG. 7 is a representative page that is displayed by the system when the end user selects the Top placements by E*IQ link in the navigation panel;

FIG. 8 is a representative page that is displayed by the system when the end user selects the Introduction link in the Find your avails link subdirectory in the navigation panel;

FIG. 9 is a representative page that is displayed by the system when the end user selects the Browse all avails link in the navigation panel;

FIG. 10 is a representative page that is displayed by the system when the end user selects the Film Tab in the display panel of FIG. 9;

FIG. 11 is a representative page that is displayed by the system when the end user selects one of the entries in the table displayed in the display panel of FIG. 10;

FIG. 12 is a representative Fixed price offer page that is displayed when the end user selects the Make offer button in the page displayed in FIG. 11;

FIG. 13 is a representative page that is displayed when the end user selects the Pay for performance tab in the page displayed in FIG. 12;

FIG. 14 is a representative page that is displayed by the system when the end user selects the Find a specific avail link in the navigation panel;

FIG. 15 is a representative page that is displayed by the system when the end user selects the Propose an integration link in the navigation panel;

FIG. 16 is a representative page that is displayed by the system when the end user selects the Select a program tab from the Propose an integration display panel;

FIG. 17 is a representative page that is displayed by the system when the end user selects the View program details tab from the Propose an integration display panel;

FIG. 18 is a representative page that is displayed by the system when the end user selects the Introduction link in the Review your offers subdirectory in the navigation bar;

FIG. 19 is a representative page that is displayed by the system when the end user selects the Show offer status link in the navigation bar;

FIG. 20 is a representative page that is displayed by the system when the end user selects the Review offer history tab in the Review your offers display panel; and

FIG. 21 is a representative page that is displayed by the system when the end user selects the Make a new offer link in the navigation panel.

### DETAILED DESCRIPTION OF THE PREFERRED EMBODIMENT

FIG. 1 illustrates a representative service provider or system architecture, which in the preferred embodiment is implemented in or across one or more data centers. A data center typically has connectivity to the Internet. In one embodiment, the system provides a web-based hosted solution through which business entities create, manage and monitor their brand integration and product placement activities in an online manner. Participants interact with the platform to buy and sell brand integration opportunities as an online marketplace. In an alternative embodiment, the system may be implemented over a private network, or as a product (as opposed to a hosted or managed service).

A business entity user has a machine such as a workstation or notebook computer. Typically, a business entity user accesses the service provider architecture by opening a web browser on the machine to a URL associated with a service provider domain or subdomain. The user then authenticates to the managed service in the usual manner, e.g., by entry of a username and password. The connection between the business entity machine and the service provider infrastructure may be encrypted or otherwise secure, e.g., via SSL, or the like. Although connectivity via the publicly-routed Internet is typical, the business entity may connect to the service provider infrastructure over any local area, wide area, wireless, wired, private or other dedicated network. As seen in FIG. 1, the service provider architecture 100 comprises an IP switch 102, a set of one or more web server machines 104, a set of one more application server machines 106, a database management system 108, and a set of one or more administration server machines 110. A representative web server machine 104 comprises commodity hardware (e.g., Intel-based), an operating system such as Linux, and a web server such as Apache 2.x. A representative application server machine 106 comprises commodity hardware, Linux, and an application server such as WebLogic 8.1. The database management system 108 may be implemented as an Oracle database management package running on Solaris. In a high volume use environment, there may be several web server machines, several application server machines, and a number of administrative server machines. Although not shown in detail, the infrastructure may include a name service, other load balancing appliances, other switches, network attached storage, and the like. The system typically will also include connectivity to external data sources, such as third party databases that provide historical data. Representative third party data sources include, for example, A.C. Nielsen PlaceViews™ (for television), Brand Cameo (for film), American Brandstand (for music), and the like. Each machine in the system typically comprises sufficient disk and memory, as well as input and output devices. Generally, the web servers 104 handle incoming business entity provisioning requests, and they export a display interface that is described and illustrated in more detail below. The application servers 106 manage the data and facilitate the marketplace functions of the platform. The administrator servers 110 handle all back-end accounting and reporting functions. The particular hardware and software implementation details described herein are merely for illustrative purposes are not meant to limit the scope of the present invention.

As noted above, the system manages avails, wherein an avail is an aspect of a production that is “available” for potential product placement and brand awareness. Typically, an “avail” is an opportunity for an advertiser, advertising agency, media buyer or the like to include a brand as part of a given production. (A “brand” is sometimes used herein to refer to an advertiser itself). An “avail” may also refer to an opportunity that is entered into the system by the seller, or on behalf of the seller, typically a producer, an entertainment network, a film production house, a music video company, a video game producer, or the like. As noted above, any such buyer or seller entity interacts with the platform over the Internet or other private network, preferably using a web browser or other graphics display engine. The system allows sellers to create, store, respond to, and transact on new avails. Similarly, the buyer uses the system to follow the progress of its offers, to respond to, and to close on avail buying opportunities.

As also described above, the system defines a set of one or more product placement-specific metrics that are used on the platform as a standard measure of delivery of exposure across avails. A brand integration unit (e.g., a UBI™, which is a trademark of NextMedium, Inc.) preferably is a function of: exposure duration (typically measured in seconds) times a given audience size metric (e.g., household (HH) gross rating points (GRP), such as available from A.C. Neilsen or other sources) times a given product placement type factor or attribute. The brand integration unit may be normalized, or calculated using other criteria. A “placement type” is a type of product placement within a given production, e.g., a foreground placement, a background placement, a brand mention, a dialogue mention, a dialogue mention by a given character, use as a prop, use in wardrobe, use in a storyline, use as the storyline, or the like. The above product placement types are merely representative. Typically, different weights are associated with each placement type, thus influencing the brand integration unit value calculation. Thus, for example, a dialog mention has a higher weight than a foreground placement, which has a higher weight than a background placement. The weight values may be informed or influenced by historical data or other statistics. An aggregate of brand integration units, e.g., over all media, or with respect to a specific media type, over a continuing time period, is as an ENTERTAINMENT INTEGRATION QUOTIENT™ (or E*IQ™). Typically, an end user entity buys a UBI and the system measures E*IQ, which value typically increases over time and use of the system. E*IQ thus is an aggregated view of the effectiveness of a brand across some or all of the media types over time. Another metric is a media value, which represents, once again preferably for a given time period, a monetary amount typically calculated as E*IQ times a quotient of: average advertising rate and average audience size (e.g., measured as HH GRP or equivalent). The media value may be calculated and displayed on an aggregate media basis, or with respect to a specific media type, or the like.

Business entities access the platform over the Web, authenticate, and then access the platform functions by navigating through display pages that comprise a graphical user interface. The following are representative, non-limiting use scenarios for the interactive marketplace of the present invention.

A buyer (an agency media buyer for a brand, such as Ford®) end user logs into the system and wants to find avails for purchase. He or she searches TV avails for a given product category (e.g., automobiles) according to a media type, in this case TV. After finding that a desired show (e.g., “Grey's Anatomy”) has an avail to his or her liking, he or she views its details (price and placement types), and places an offer.

In another example, a buyer (Revlon® media buyer) logs into the system and wants to find out avails to purchase. In this case, however, no seller has entered avails for cosmetics. In this case, the end user does an advanced search entering parameters, such as target demographic (Women 18-49) and top shows (per HH GRP or E*IQ) in a desired category. The system then performs a data mining function for top shows (e.g., based on HH GRP or E*IQ) and lists them. The relevant data may be located in the system databases, or the system may execute the search by connecting to remote (possibly third party) databases or other data sources. Once the search is complete and the results returned, the user is then able to send messages to the seller, e.g., to initiate integration (in particular, a dialog between buyer and seller to include avails for Revlon).

As yet another example, assume that FOX® Racing is a new system customer. The system data mines placement information to find out top exposures, GRP, and E*IQ for FOX Racing. It then compares this data with FOX Racing's top competitors. Assume that the system discovers that, even though FOX Racing has the highest exposures and GRP in a given television show, its E*IQ is lower than its competitors. As a result, the system recommends avails that will help FOX Racing increase its own E*IQ. FOX Racing can then purchase these avails. Another example scenario assumes that FOX has an exclusive brand integration deal with Coke for a television show such as American Idol®. FOX wants to ensure that, when Coke's competitors log into the system, they are shown avails for all FOX shows except American Idol. FOX enters this information into the system and the system ensures that when Pepsi's brand manager logs in, it is not shown American Idol avails.

Another example is that the FOX TV sales team is creating a new show similar to American Idol. It wants to enter avails into the system but needs help in pricing them. The system provides a pricing calculator that then recommends prices based on similar shows and historical data.

In another use example, assume that Revlon's brand manager has signed up for a series of avails in the “cosmetic” product category for Fall TV shows on FOX. She wants to audit the exposure. She logs into the system and brings up an exposure history for her deals. The system preferably displays statistics in terms for duration, GRP and E*IQ, and the page may also includes links to video clips featuring Revlon.

Coke's brand manager wants to compare how his brand fares in product placements on top shows with respect to Pepsi over the past calendar quarter. The end user logs into the system to see this report. The end user can then change dates and captures this information for GRP, occurrences, and E*IQ.

As another example, assume that the “Real World-Road Rules” production company wants to sell all avails for a cell phone category for the 2007 television season (all episodes). It logs into the system and places this “brand integration” sale. The brand manager for T-Mobile® then logs into the system, searches for cell phone integration deals and places an offer for the “Real World-Road Rules” program.

As still another example, assume that the script in a new TV series calls for the lead actress to drive environmentally friendly cars. The network and production company for this series want to sell automobile avails for all episodes to an automobile brand and feature its various environmentally friendly vehicles. The end user logs into the system and defines the brand integration opportunity. Brand managers for Toyota, Ford, and Honda can then access the system and negotiate for the opportunity.

Another example assumes that a seller receives offers, e.g., from Hyundai and Jaguar, with respect to an avail to include cars in a scene with a lead actress in a forthcoming James Bond movie. Even though the offer from Hyundai is more than 30% higher than that of Jaguar, the seller accepts Jaguar, because the offer is more in line with the script. However, instead of rejecting Hyundai, the seller sends back a counter-offer to include the brand in other parts of the film.

As still another example, Ford's brand manager sees a cash offer to include cars as part of a new TV action series. Instead, the brand manager responds to the offer with a counterproposal, namely, a lower price per avail and providing all of Ford's 2007 model year cars for free to be used in the show. The seller responds and agrees with this offer.

The producer for the “Amazing Race” TV series wants to construct an open-ended offer, as follows. The offer includes an automobile product category opportunity in each weekly show, however, the producer cannot give specifics (e.g., duration) of each occurrence given that the show is loosely scripted. The end user then constructs a deal such that the brand will pay a minimum amount upfront with a remainder paid post-airing of the show, e.g., based on some metric such as dollars per duration, GRP or E*IQ. The GRP metric can be obtained from a third party measurement source and imported into the system, which can then audit and manage the overall transaction.

The system also enables producers to put in a generic description for a series of avails and ask for an upfront fee followed by a pay-for-performance model based on some dollars per duration, GRP or E*IQ. In this example, cell phones will be used in all episodes for a new TV series. Producers can use this feature to sell series of avails without significant upfront work, such as entering specific data (time, duration, script mention, and the like), and buyers can use this feature obtain a scientific measurement (analogous to pay per click) for avails, as preferably the system has access to third party measurement data, as previously noted.

Denny Restaurant's brand manager wants to obtain a report on the TV shows and films that have carried the brand and measure their effectiveness. The system's business intelligence database preferably list all shows, their GRP and exposures, including links to clips that feature the brand. The system also exposes the brand's E*IQ with respect to its competition and enables the manager to investigate how to increase the E*IQ across all media types. The system then provides this information and lists recommendations.

As a final example, assume that the brand manager for Ford has $1M to spend on brand integration across various media types (TV, films, video games, music). He logs into the system to create a product placement campaign. The system can then recommend a series of avails that will help the manager obtain a maximum return on investment.

The above examples are merely illustrative and are not to be taken to limit the present invention in any way. As can be seen, the system provides many advantageous features. In particular, the system automates the key aspects of today's manual and labor intensive product placement & brand integration workflow by providing avail listing and search capability, as well as enabling participants to make and respond to offers. The platform provides a central, one stop (create, manage and transact) location to manage product placement and brand integration across all media types (TV, films, music, video games, and the like). It provides participants with the ability to introduce and execute on new business models, such as pay-for-performance for product placement and brand integration. The system also affords users with access to historical product placement data for business intelligence reports, it provide new metrics (e.g., UBI and E*IQ) to measure efficacy of product placements and to define an overall media value for a brand. Moreover, the system, through its guided interface to be described below, provides actionable data, tasks and tools to guide the user to intelligently use these metrics. More generally, the system enables participants to increase market size for product placement and brand integration by allowing sellers to target a larger audience of buyers, and vice versa.

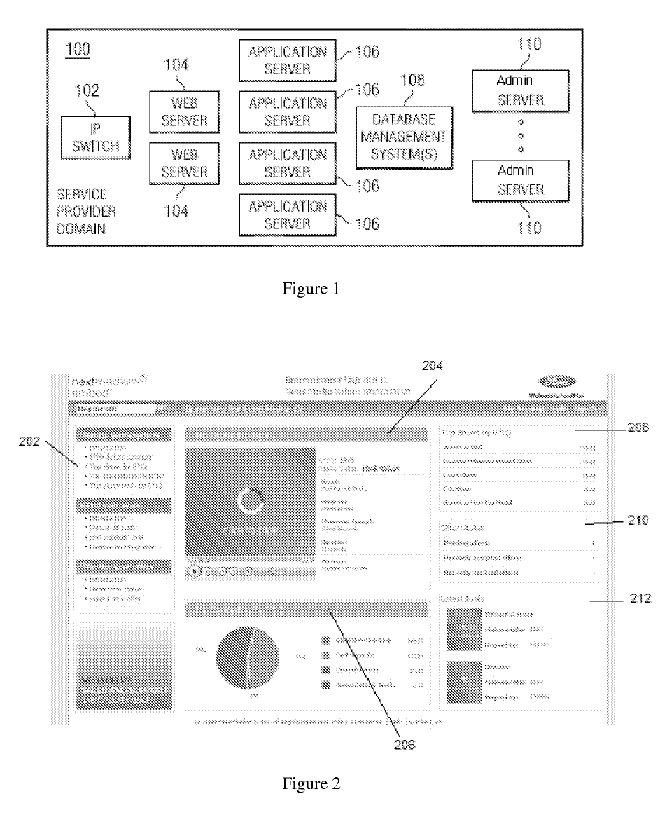

Preferably, participants interact with the system through a Web-based portal and, in particular, through a series of display pages exported to a web browser. These display pages are illustrated in FIGS. 2-22, by way of example. The particular sequence and organization of these pages is merely representative, as are the particular layouts of each given page. Nevertheless, the basic functions of the system can be visualized by navigating through these displays, as will now be described at a high level.

FIG. 2 is a representative home or “portal” page from which an end user can navigate throughout the system functions. The page comprises a navigation panel 202 with various links to other pages that are described below. A Top Recent Exposure panel 204 exposes details for a highest value product placement for this particular participant (in this example, the Ford brand manager). This panel includes an embedded media player (to play the content), the E*IQ, the Media Value, the brand, the program, the placement type, the duration and its air-time. A Top Competitors by E*IQ panel 206 shows the end user how the Company's branding opportunities are faring with respect to other identified competitors. A Top Shows by E*IQ panel 208 displays the shows that are providing the best return on investment for the brand. An Offer Status panel 210 displays offer information. A Latest Avails panel 212 displays one or more recent avails that have been placed or to which the manager has responded.

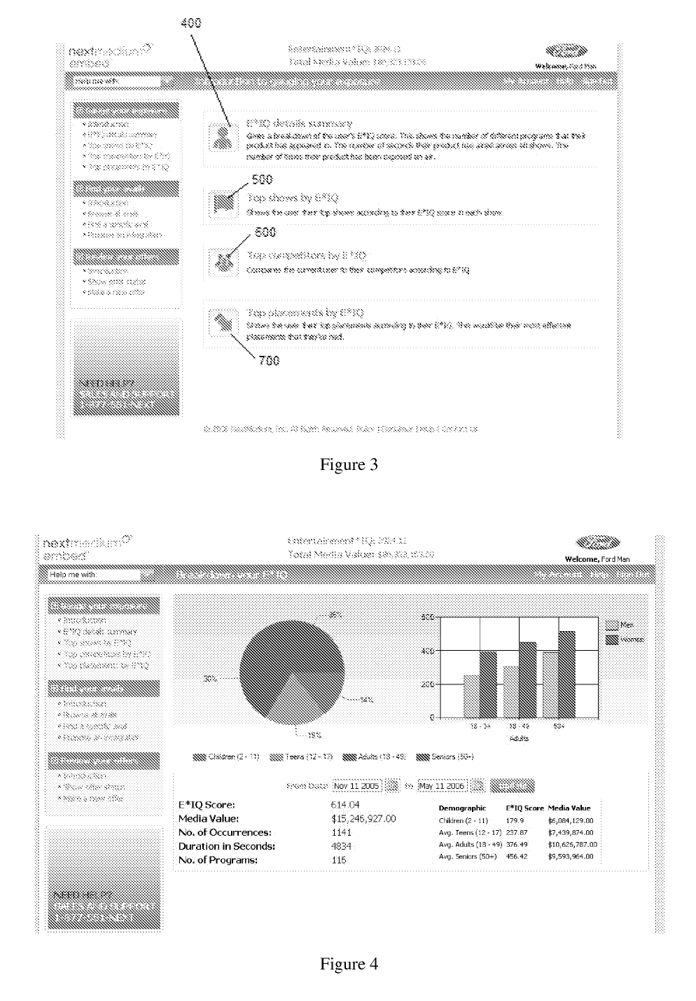

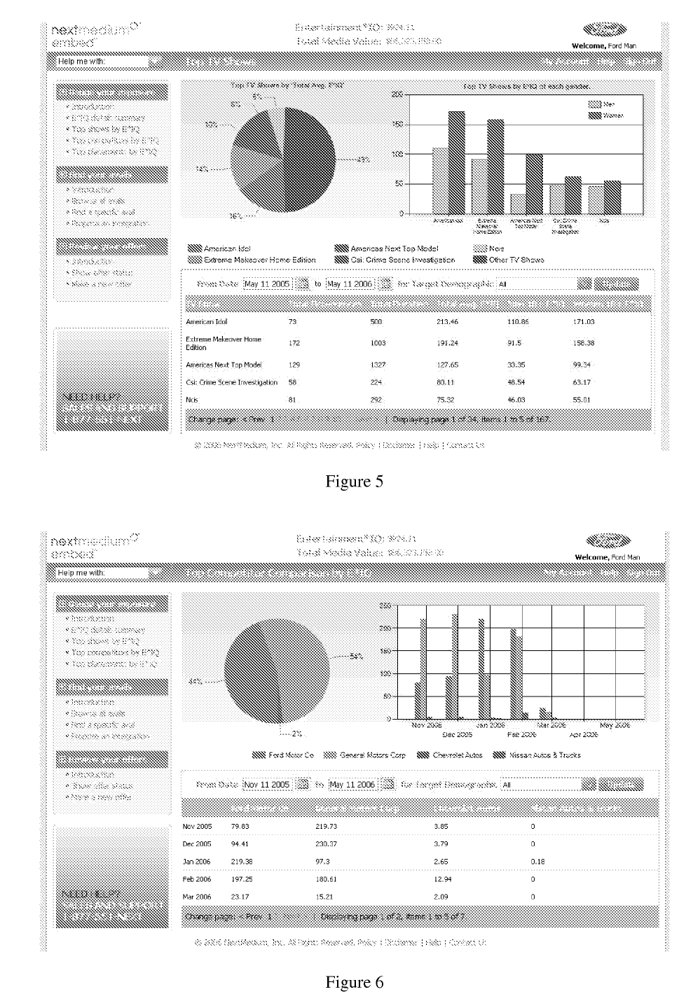

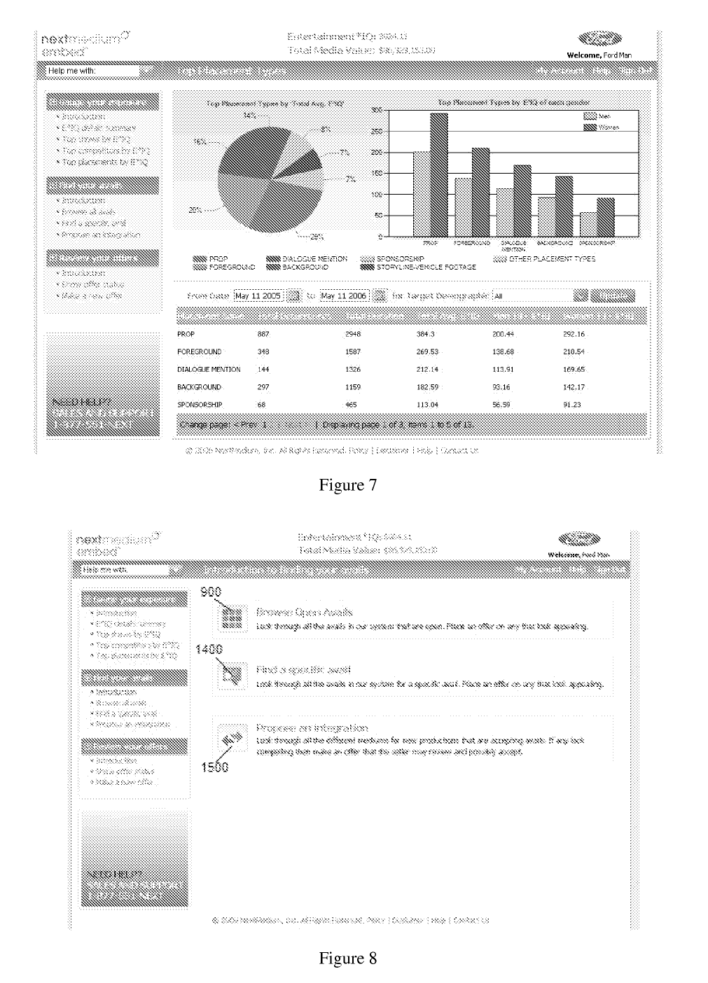

FIG. 3 is a representative page that is displayed by the system when the end user selects the Introduction link in the Gauge your exposure subdirectory identified in the navigation panel. It includes a number of image links. When the end user selects the E*IQ details summary image link 400, he or she is navigated to the display page in FIG. 4, which provides a breakdown of the brand's E*IQ score. This page thus shows the number of different programs that the brand's product has appeared in, the number of seconds the product has aired across all shows, and the number of times the product has been exposed on air (or the like). The Breakdown your E*IQ page in FIG. 4 also shows associated demographic data. Referring now back to FIG. 3, when the end user selects the Top Shows by E*IQ image link 500, he or she is navigated to the display page in FIG. 5, which shows the user the brand's top shows according to their E*IQ score in each show. As seen in FIG. 5, this table also displays additional data such as total occurrences, total duration, total average E*IQ, and E*IQ broken down by demographics. Referring once again back to FIG. 3, when the end user selects the Top Competitors by E*IQ image link 600, he or she is navigated to the display page in FIG. 6, which includes data comparing the brand to its competitors according to E*IQ. Given temporal and percentage data preferably is also shown, as indicated. As also seen in FIG. 3, when the end user selects the Top Placement Types by E*IQ image link 700, he or she is navigated to the display page in FIG. 7, which includes data (total occurrences, total duration, total average E*IQ, and E*IQ broken down by demographic) by one or more placement types: prop, foreground, background, dialogue mention, sponsorship, storyline, and other. The data can be indexed by date, as indicated.

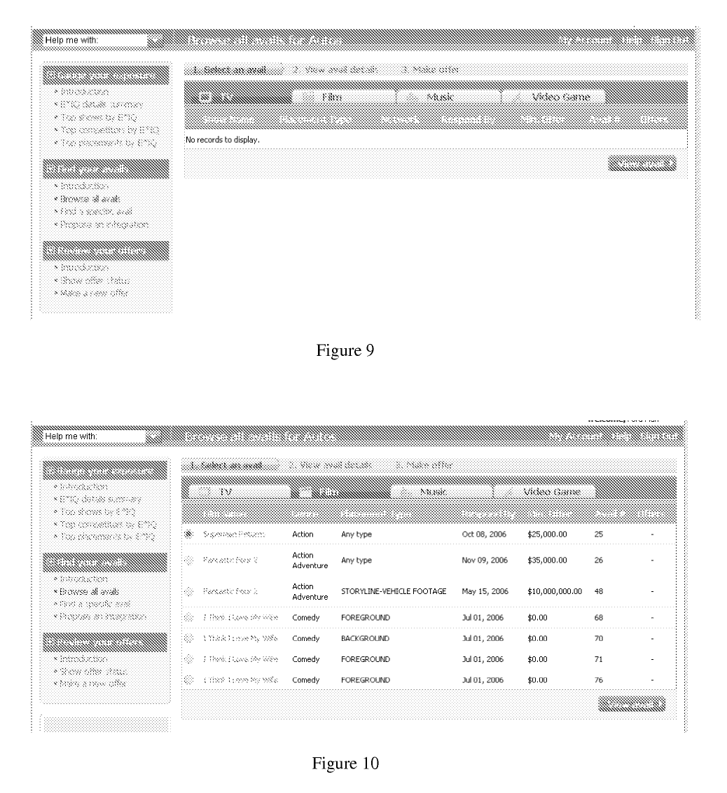

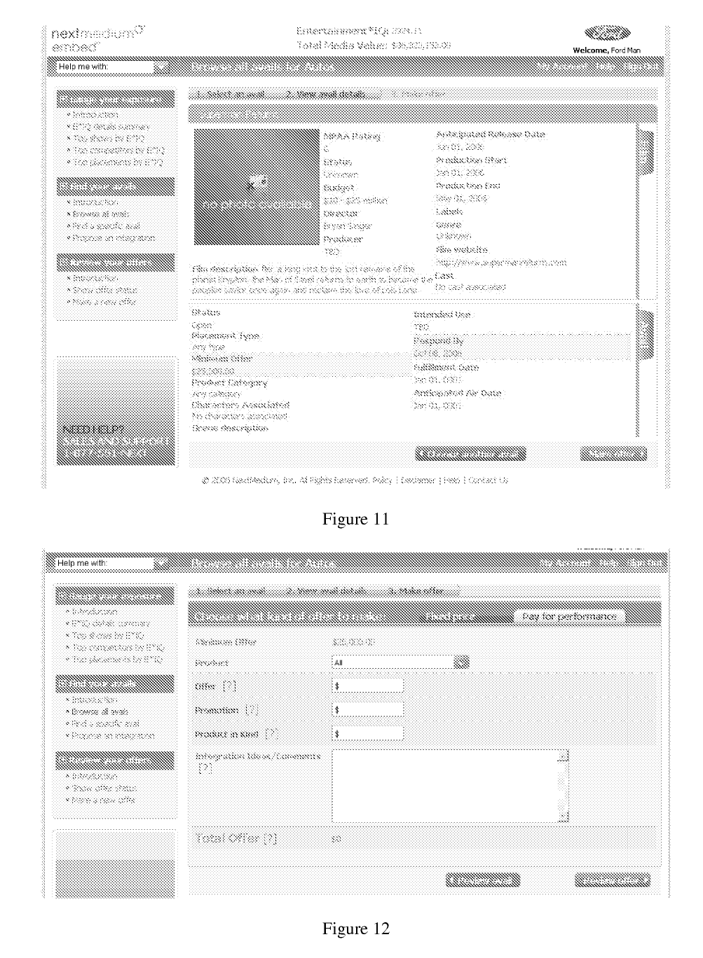

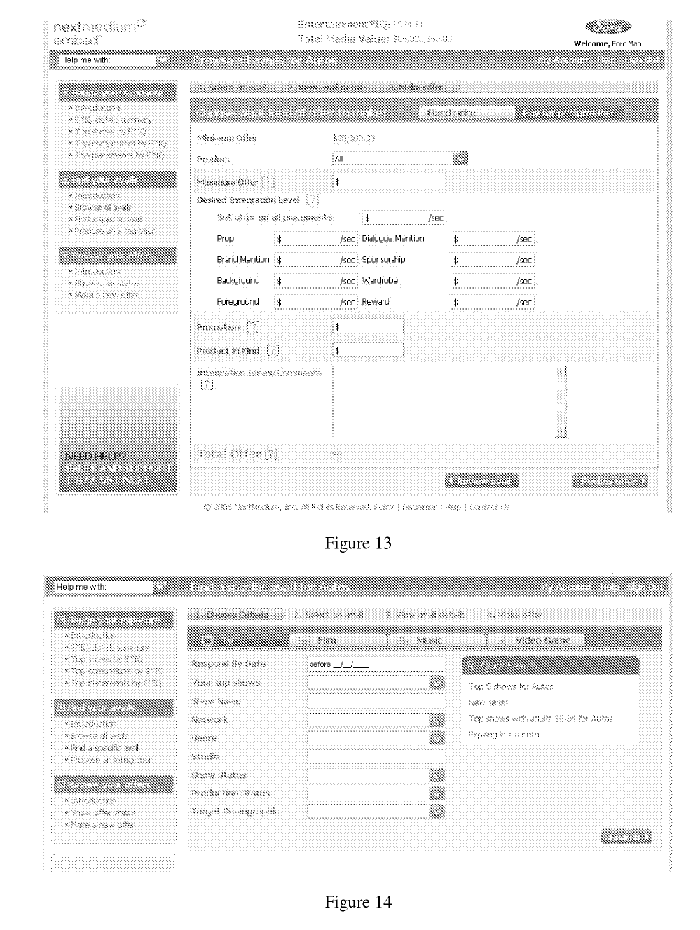

FIG. 8 is a representative page that is displayed by the system when the end user selects the Introduction link in the Find your avails link subdirectory in the navigation panel 202 shown in FIG. 2. This panel includes a set of image links. When the end user selects the Browse Open Avails image link 900, he or she is navigated to the display page shown in FIG. 9, which enables the user to look through open avails in the system, perhaps indexed by category (e.g., automobiles). As seen in FIG. 9, the avails preferably are also organized by media type, e.g., television, film music, or video game. The television page is shown by default, but this is not a requirement. By navigating to the desired media type page, the user can review the avails. In this example, there are no television opportunities available for automobiles, which in this example is the relevant category for this particular user. By selecting the Film tab, however, the user can navigate to the display page in FIG. 10, which includes a list of avails, indexed by Film Name and including associated information such as genre, placement type, a response deadline, a minimum offer, and the number of offers outstanding. Selection of a link in this page navigates the user to the display in FIG. 11, which provides detailed information for the particular offer selected. FIG. 11 includes a Make offer button, and selection of this button navigates the user to the display page shown in FIG. 12, which includes a fill-in form by which the user can enter the offer details. As can be seen in FIG. 12, preferably the page includes a minimum offer field, a list box that includes a listing from which a product can be selected, an offer field, a promotion field, and a product-in-kind field. The user enters given amounts into these fields as desired, and he or she can add additional comments or integration ideas in the comment field. In the alternative, the end user can select the Pay for performance tab and be navigated to the display page in FIG. 13. This page exposes a fill-in form that enables the user to create a custom pay for performance offer that includes a maximum offer, a desired integration level (if supported), a set offer (preferably measured in $/sec) on all placements field, as well as separate placement type fields as indicated. Thus, the user can designate a given price that it is willing to pay to get its brand mentioned by a character, or positioned in a foreground shot, or as a part of a character wardrobe, and the like. This pay for performance feature is quite useful, as it enables performance-based bidding and fulfillment. This is desirable, especially for entities that have no control over the execution of a given creative.

Returning now to FIG. 8, when the end user selects the Find a specific avail image link 1400, he or she is navigated to the display page shown in FIG. 14, which enables the user to look through all the avails in the system for a specific avail. As illustrated in FIG. 14, this page includes a search engine that is indexed by media type, and that includes a set of fill-in options including a response deadline, a top shows list box, a show name field, a network list box, a genre list box, a studio field, a show status list box, a production status list box, and a target demographic list box. Entry of data in this fill-in form controls the search engine to return the avails, from which the user can then review and prepare an offer, as has been described above.

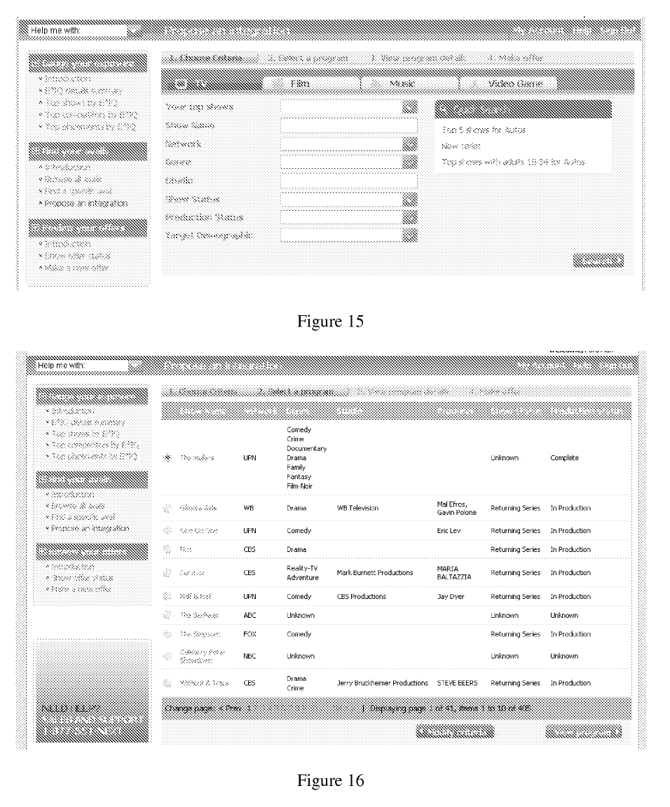

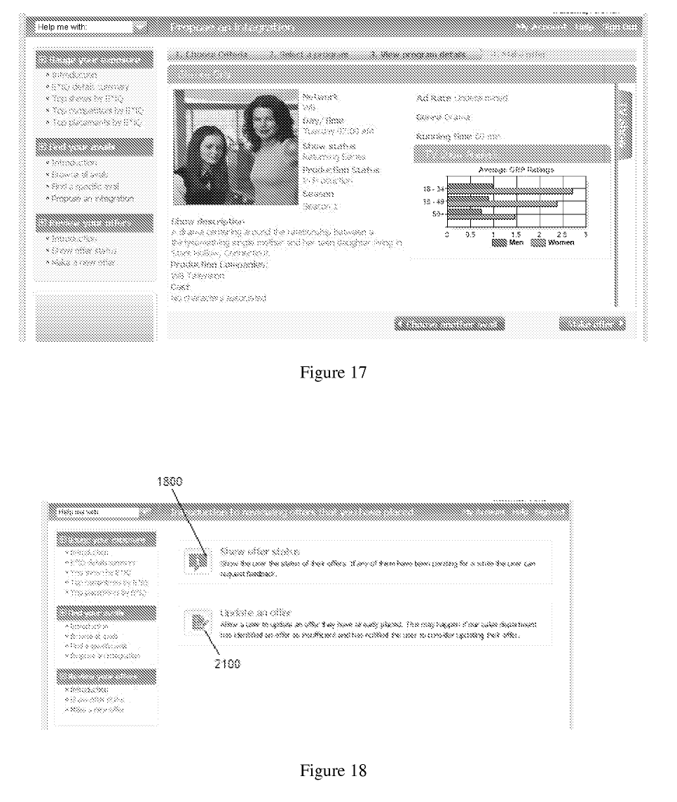

Referring again to FIG. 8, when the user selects the Propose an integration image link 1500, he or she is navigated to the page shown in FIG. 15. Using this page, the user can enter criteria for a given integration and search through the database, once again indexed by media type and by entering information in the various fields shown. FIG. 16 is a representative page that is displayed by the system when the end user selects the Select a program tab from the Propose an integration display panel. FIG. 17 is a representative page that is displayed by the system when the end user selects (e.g., by clicking on a radio button) a given program and the clicks the View program details tab.

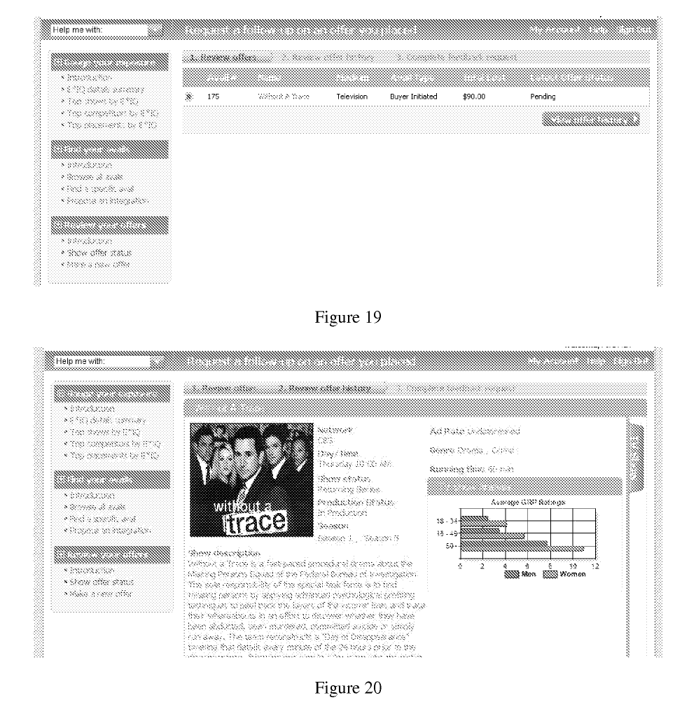

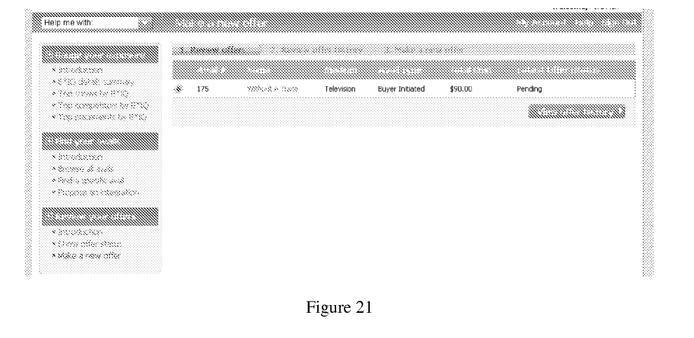

FIG. 18 is a representative page that is displayed by the system when the end user selects the Introduction link in the Review your offers subdirectory in the navigation bar. This page includes preferably includes a set of image links. A first image link 1900 navigates the user to the display page in FIG. 19, which shows the user the status of their current offers. He or she can select the View offer history button and be navigated to the display page shown in FIG. 20. If any of these offers have been pending for a given time period, the user can request feedback from other users using tools accessible through this page. As also seen in FIG. 18, if the user selects the second image link 2100, he is she is navigated to the Update an offer page shown in FIG. 21. The user can use this page to update an offer they have already placed.

As can be seen, the various display screens can be accessed through the links in the navigation panel 202, or through the image links on the pages that are exposed during the typical user navigation.

As noted above, preferably the web-based marketplace has access to or otherwise integrates with third party sources that include historical product placement data. This information facilitates the generation of the real-time and historical data shown in the representative displays. Access to exposure data allows the system to create audit trails and to introduce new business models around product placements and brand integration. The system may also include processing routines that use the historical data (and perhaps data specific to a particular brand, category, production, or the like) to predict and recommend avails to the user. Access to historical data allows the service provider to data mine for recommendations and to predict trends. Further, the product placement-specific metrics (UBI & E*IQ) provide the users and others with a standard measure of delivery of exposure across avails. As noted above, preferably E*IQ is an aggregated view of the effectiveness of a brand across some or all of the media types.

The present invention provides the marketplace participants with the ability to track and manage product placement and brand integration opportunities throughout an entire media production and distribution lifecycle that includes some or all of the following: pre-production, production, post-production, broadcast/distribution, as well as post-broadcast interactivity or other transactional commerce. Thus, for example, in pre-production, a seller can reveal an apparel opportunity for a popular television show. In the production phase, a buyer can then bid on the avail and, if the bid is accepted, purchase the opportunity. Or, assuming the opportunity is not then closed, an entity may decide to make a bid during the post-production phase. During the broadcast distribution phase, a buyer may even purchase an avail if its brand or branded product can be placed into the production in a “virtual” manner. Even following broadcast distribution, yet another buyer can purchase an opportunity with respect to downstream distribution (such as foreign broadcast rights). Thus, using the platform, different buyers can offer different product placements throughout the production and distribution lifecycle of a given creative.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the network are not a limitation of the present invention. A given machine includes network interfaces and software to connect the machine to a network in the usual manner. As illustrated in FIG. 1, the present invention may be implemented as a managed service (e.g., in an ASP model) using the illustrated set of machines, which are connected or connectable to one or more networks. More generally, the service is provided by an operator using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., Java applets or servlets, linkable libraries, native code, or the like, depending on platform), that provide the functionality of a given system or subsystem. As described, the service may be implemented in a standalone server, or across a distributed set of machines. Typically, a server connects to the publicly-routable Internet, a corporate intranet, a private network, or any combination thereof, depending on the desired implementation environment.

Having described our invention, what we now claim is set forth below.

1. In a computer system that provides a web-based hosted service, a method comprising:
providing a marketplace through which participating entities can create, respond to, and transact on product placement and brand integration opportunities; and
generating a set of one or more metrics associated with a given opportunity.

2. In the computer system as described in claim 1 wherein the set of one or more exposure metrics include a brand integration unit that is a function of exposure duration, a given audience size metric, and a given product placement type factor.

3. In the computer system as described in claim 2 wherein the product placement type factor is selected from one of: a foreground placement, a background placement, a brand mention, a dialogue mention, a dialogue mention by a given character, use as a prop, use in wardrobe, use in a storyline, and use as the storyline.

4. In the computer system as described in claim 3 wherein a given product placement type factor has an associated weight.

5. In the computer system as described in claim 2 wherein the set of one or more metrics include an aggregate of brand integration unit values.

6. In the computer system as described in claim 5 wherein the brand integration unit values are aggregated over a set of one or more media types.

7. In the computer system as described in claim 6 wherein the media types are one of: television, film, music and video games.

8. In the computer system as described in claim 5 wherein the set of one or more metrics include a media value, wherein the media value is a monetary amount that is a function of the aggregate of brand integration values and a given audience metric.
